(19) United States
(12) Patent Application Publication
(10) Pub. No.: US 2005/0083642 A1
(43) Pub. Date: Apr. 21, 2005

(54) Mobile communications device, and display-control method and program for mobile communications device

(76) Inventors: Tsuyoshi Senpuku, Tokyo (JP); Hirohiko Higuchi, Tokyo (JP); Tomoaki Tsukada, Tokyo (JP); Daisuke Iizawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/499,653

(22) PCT Filed: Mar. 8, 2002
(86) PCT No.: PCT/JP02/02197

(51) Int. Cl. G06F 1/16

(52) U.S. Cl. 361/681; 455/575.4; 455/556.1; 345/169; 345/905

(57) ABSTRACT

A mobile communications device includes a first display device and a second display device. The second display device is arranged on, and is movable with respect to, a casing, and movement of the second display device is detected by a sensor. Moreover, the mobile communications device may include a control device for executing application programs, and when the second display device is moved, automatically updates display content on the first display device or the second display device in cooperation with the movement. When the second display device changes from closed status to open status, the control device automatically selects content related to content on the first display device and displays it on the second display device.

### TECHNICAL FIELD

The present invention relates to mobile communications devices such as mobile phones and mobile information terminals having wireless communication functions, to display-control methods and programs for such devices, and in particular, to such devices having multiple displays.

### BACKGROUND ART

Heretofore, various types of mobile phones have been developed and are in use, but most of them have only one display. There is, however, a mobile phone with multiple displays described in Japanese Laid-Open Patent Publication 1997-247250. With this mobile phone, by utilizing two foldable displays as one screen, text messages by e-mail or wireless calls, and large amounts of data from facsimiles or personal computers, can be displayed.

The above-described mobile phone prior art, however, merely discloses mobile communications device displaying large amounts of information with the implementation of multiple displays and does not show any specific technology for improving the user interface regarding operation of the multiple displays, and therefore remains an issue that improved user operability for displaying, for example, by switching among multiple displays, has not yet to be devised.

### DISCLOSURE OF INVENTION

The present invention is provided to solve the above-explained problems, and aims at improving the user interface of a mobile communications device having multiple displays.

The mobile communications device of the invention comprises: a casing; a first display device for displaying text or images; a second display device that is arranged on, movable with respect to, the casing; a sensor for generating signals according to the position of the second display device; and a control device for executing application programs and displaying first execution results on the first display device, and for displaying second execution results, related to the first execution results, on the second display device based on output signals from the sensor when the second display device is moved into a predetermined position.

Alternatively, the control device is configured to enable a plurality of application programs to be executed, and when it displays a second execution result on the second display device, the control device displays the result of executing an application program that the first display device is using.

Alternatively, the control device executes email-browsing programs as application programs, and the first display device displays an receiving list of e-mails as a first execution result, and the second display device displays content of an e-mail in the receiving list as a second execution result.

Alternatively, the control device displays on the second display device a help display for a first execution result currently being displayed when the second display device is moved into operable position.

Alternatively, the first display device displays a menu having a plurality of displayed options; and when the control device has judged based on an output signals from the sensor that the second display device has been moved, then the control device judges that one option has been selected from the plurality of options.

Alternatively, based on output signals from the sensor the control device selects on which display device to display a second execution result, and displays the second execution result on the first display device or the second display device according to the selection result.

Alternatively, the sensor detects open and closed state of the second display device; and when the sensor has detected that the second display device has gone from being the open state to the closed state, then the control device displays on the first display device an synthesized image in which content displayed on the first display device when the second display device was open and content displayed on the second display device when the second display device was open, are synthesized.

Alternatively, the mobile communications device comprises a camera for taking first video images, and each of the first display device and the second display device respectively displays either a second video image, which is sent from a communication partner, or a first video image in the open state; and when the sensor has detected that the second display device has gone from the open state to the closed state, then the control device reduces the first video image, synthesizes the reduced first video image and the second video image, and displays the synthesized video image on the first display device.

Alternatively, the mobile communications device comprises an input device for selecting the content displayed on the first display device or the second display device, and based on signals from the sensor, the control device determines the second display device will not display, and selects, as an active screen, the display device, which is to be operated by the input device, from between the first and second display devices, and updates the content on the first display device using the content on the active screen when the second display device has gone into non-display status.

A display control method of the invention comprises: a detection step of detecting whether second display device has changed from being not-in-use to being in-use, wherein first display means and the second display means are provided in the mobile communications device; and a display step of selecting display content related to an option displayed on the first display means from a plurality of display-content items, and displaying the display content on the second display means, when the change into the state of inuse has been judged in the detection step.

Alternatively, the display step displays on the second display means the next execution results from an application program using the first display means.

Alternatively, the display step displays the second execution result on the first display means when the second display means is not being used and a decision button on the mobile communications device has been pushed.

Alternatively, the detection step detects output signals from a sensor for detecting that the second display means has moved with respect to the first display means.

Alternatively, the display control method further comprises a list-display step of displaying on the first display means an e-mail received list having a number of subject headings, and a designation step of designating one email from the received list; wherein the display step displays detailed content of the e-mail designated in the designation step as content for display on the second display means.

Alternatively, the display control method of the invention further comprises: a step of receiving a first video image sent from a communication partner; a step of taking a second video image using a camera provided in the mobile communications device; a dual-screen display step of displaying the first and second video images at the same time by means of the first and second display means and displaying the first and second video images on either the first or second display means; and a single-screen display step of synthesizing and displaying on the first display means the first and second video images when the second display device has gone from being not-in-use to being in-use.

Alternatively, the single-screen display step shrinks the second video image and synthesizes the first and the second video image.

Alternatively, when the second display device has gone to being in-use, then the display step displays a help display related to the content displayed on the first display device.

Moreover, the display control method of the invention may further comprise: a step of detecting an input signal from an input device, the input device being provided for selecting content displayed on the first display means or the second display means; a step of selecting display content based on the input signal from the first input device; a step of displaying different content on the first display means and the second display means respectively; a step of selecting based on a signal from the first input device either the first display means or the second display means as an active screen to be controlled based on a signal from a second input device provided in the mobile communications device; and an update step of updating the content displayed on the first display device using the content displayed on the active screen, when the second display device has gone to being not-in-use.

Programs according to the invention execute any of the above-described display-control methods on a computer.

### BRIEF DESCRIPTION OF DRAWINGS

FIG. 1 is a block diagram showing the configuration of a mobile communications device according to the invention;

FIG. 2 is an elevational view of the mobile communications device according to the invention;

FIG. 3 is an elevational view of the mobile communications device according to the invention;

FIG. 4 is a side view of the mobile communications device according to the invention;

FIG. 5 is a side view of the mobile communications device according to the invention;

FIG. 6 illustrates an e-mail browsing screen according to the invention;

FIG. 7 is a flow chart representing a display control method according to the invention;

FIG. 8 is a flow chart representing opening-and-closing process according to the invention;

FIG. 9 illustrates a function-setting screen according to the invention;

FIG. 10 is a flow chart representing a display control method according to the invention;

FIG. 11 illustrates a video communication screen according to the invention;

FIG. 12 illustrates a video communication screen according to the invention;

FIG. 13 is a flow chart representing a video conversation screen-switching process according to the invention;

FIG. 14 illustrates an application execution screen according to the invention;

FIG. 15 illustrates an active screen according to the invention;

FIG. 16 illustrates an active screen according to the invention;

FIG. 17 is a flow chart representing a display control method according to the invention;

FIG. 18 illustrates an application execution screen according to the invention;

FIG. 19 illustrates an application execution screen according to the invention;

FIG. 20 illustrates an application execution screen according to the invention;

FIG. 21 is an elevational view of a mobile communications device according to the invention; and

FIG. 22 is a side view of a mobile communications device of the invention.

### BEST MODE FOR CARRYING OUT THE INVENTION

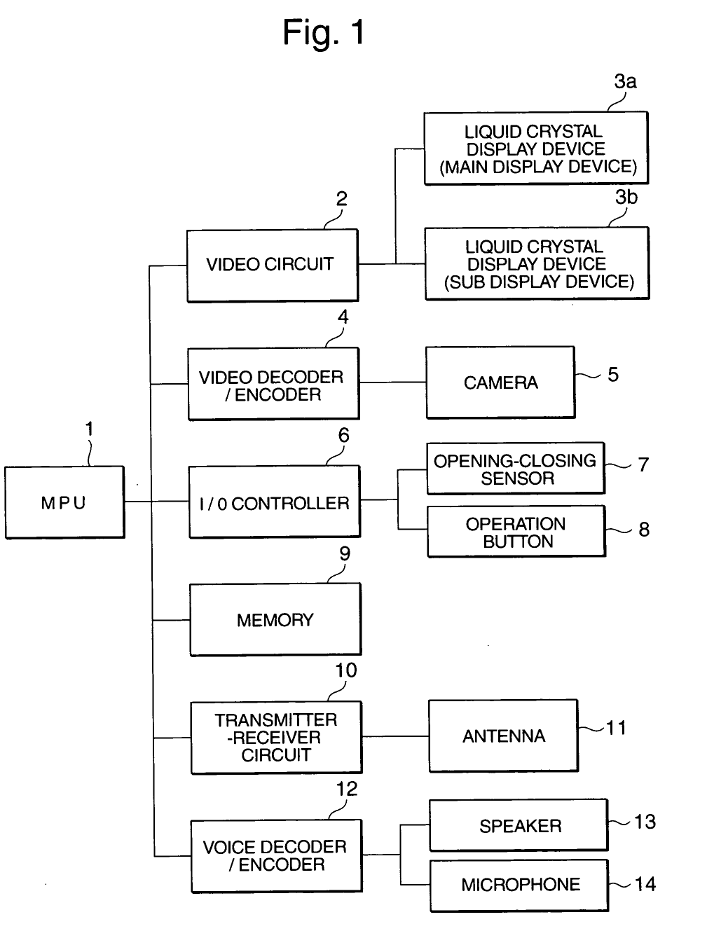

FIG. 1 is a block diagram showing details of a mobile communications device of the invention. MPU 1 (micro processing unit) has a function to control operations of each device, and is connected through a bus to a video circuit 2, a video decoder/encoder, an I/O (input output) controller 6, a memory 9, a transmitter-receiver circuit 10, and a voice decoder/encoder 12. The video circuit 2 has a video memory, which is not illustrated, and electrically drives liquid crystal display devices 3a and 3b. In the following explanation, the liquid crystal display device 3a is called a main display device and the liquid crystal display device 3b is called a sub-display device. The video circuit 2 can independently control the main display device 3a (the first display device) and the sub-display device 3b (the second display device). The main display device 3a and the sub-display device 3b display images, such as text, still images, and moving pictures, according to control signals from the video circuit 2. The video decoder/encoder 4 is a circuit having an encoder that encodes images taken with a camera 5 into compressed data in accordance with an encoding format such as MPEG4 (Moving Picture Experts Group 4), and having a decoder that decodes encoded data received through an antenna 11 and the transmitter-receiver circuit 10 and restores it into original images. A commercially available MPEG decoder-encoder IC, for example, may be used as the video decoder/encoder 4. The I/O controller 6 is an input-output processing controller that transmits input signals from various devices to the MPU 1, and transmits output signals from the MPU 1 to the various devices. The opening-closing sensor 7 is a sensor that detects the position of the moveable sub-display device 3b. For example, a switch may be provided in a position where the switch is pushed by the sub-display device 3b or its casing when the sub-display device 3b is moved into closed position. A plurality of operation buttons 8 is assigned to various functions and characters, and is used as input devices. The memory 9 stores various types of programs and data. The type of memory used (volatile memory, non-volatile memory, etc.) is what is appropriate in accordance with the type of data.

The transmitter-receiver circuit 10 is a circuit that performs voice and data communication through the antenna 11. Various types of circuit are known for the transmitter-receiver circuit 10, and the already widely used PDC (Personal Digital Cellular), GSM (Global System for Mobile Communications), and CDMA (Code Division Multiple Access) formats, or next generation communication formats, which are expected to become widely used in the future, such as WCDMA (Wide-band Code Division Multiple Access), and Cdma2000, may be used as transmitter-receiver circuit communication formats. The voice decoder/encoder 12 is a circuit that has an encoder, which encodes voice signals obtained with a microphone 14, and a decoder that decodes into voice signals encoded data received by the transmitter-receiver circuit 10. As a voice coding scheme, the CELP (Code Excited Linear Prediction) encoding scheme is widely known. The voice signals decoded in the voice decoder/encoder 12 are reproduced through a speaker 13.

In addition, the speaker 13 is not limited to reproducing voice signals but can also reproduce music and sound effects from electrical signals formed in a synthesizer circuit, which is not shown in the figure.

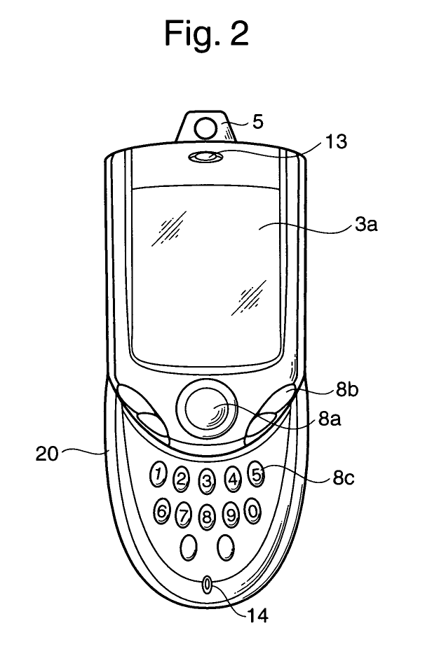

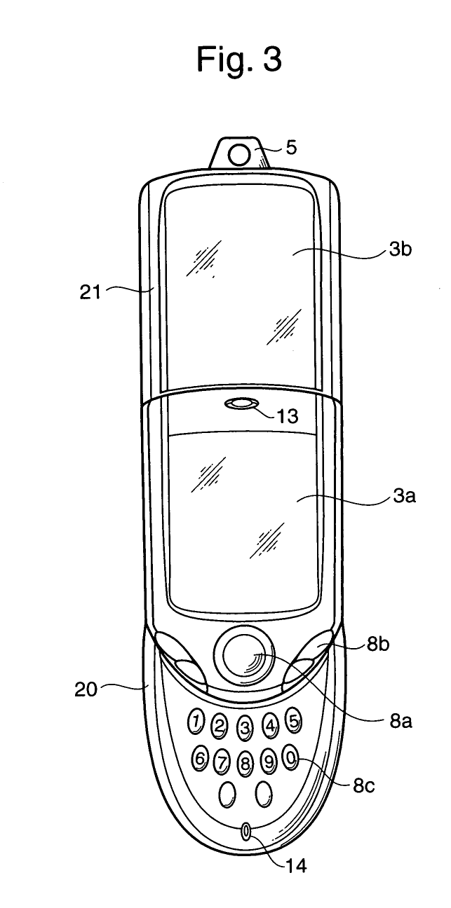

FIGS. 2 and 3 are front views of the mobile communications device, and the symbols used refer to the same or equivalent components as those in FIG. 1. Here, FIG. 2 illustrates the situation where the sub-display device 3b is hidden at the back side of the main display device 3a. The sub-display device 3b, as shown in FIG. 3, has a structure in which it slides relative to a main casing 20, and the user can use the main display device 3a in addition to 3b at the same time. Moreover, buttons 8a-8c are input devices that function as the operation buttons 8. The selector 8a has a direction-key function that generates a direction-indicating signal by the rim portion being pushed, and a decision-button function that, by the central part of the button being pushed down, confirms a designated option and indicates a next operation. For example, when the user specifies an option on a menu, by the user instructing the movement of a cursor or a highlighted display on the screen and pushing the button, the MPU 1 performs a process associated with that option. Software keys 8b, associated with an option displayed on the main display device 3a or 3b, are an input device used when execution of the displayed function has been specified. Numerical buttons 8c are an input device used to input numbers or text characters.

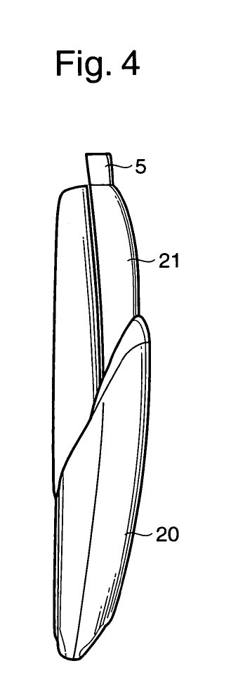

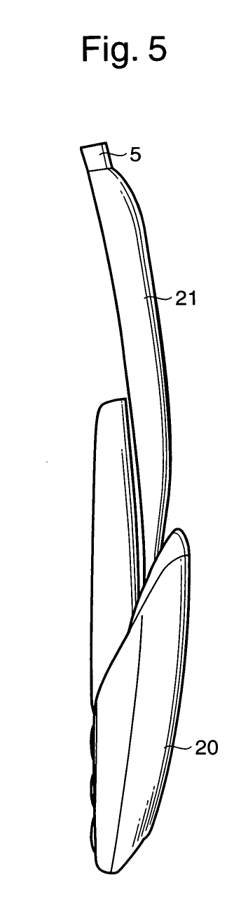

FIGS. 4 and 5 are front views of the mobile communications device shown in FIGS. 2 and 3, and the symbols used in these figures refer to the same or equivalent components as those in FIG. 1. Here, FIG. 4 illustrates a situation where the sub-display device 3b is hidden and not-in-use, as in FIG. 2. And on the other hand, FIG. 5 corresponds to FIG. 3, and illustrates the situation where the main display device 3a has been slid out relative to the main casing 20. As may be understood from FIG. 5, the main casing 20 and the sub-casing 21, which supports the sub-display device 3b, are configured such that a sliding face is on a curved surface. Therefore, when the sub-casing 21 is pulled out, since the sub-casing 21, and the camera 5 and the sub-display device 3b, are thrust out frontward with the angle changing, the camera 5 and the sub-display device 3b are set at an angle that facilitates user usage.

(1) E-Mail Receiving and Browsing Operations

Next, e-mail browsing operations using the above-described mobile communications device will be explained.

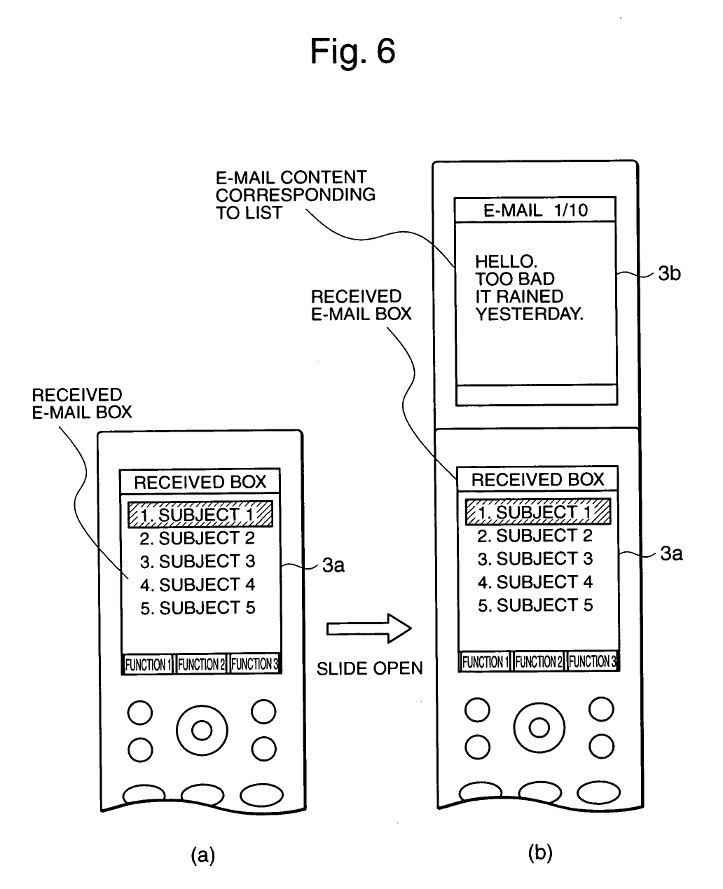

Here, a situation where a plurality of e-mails is received by the transmitter-receiver circuit 10 and is stored in the memory 9 is assumed. When the user selects a received e-mail list browsing function from the menu displayed on the main display device 3a, as shown in FIG. 6(a), a list of the plurality of received e-mail subject names, senders, transmitting times, etc. is displayed. Next, the user specifies a desired received e-mail using the button 8a. Further, in this situation, only the received e-mail is specified, and following action based on the designation does not occur.

In conventional mobile communications devices, in order to display details of received e-mail from this situation, it is necessary to push a decision button. In the mobile communications device of this invention, on the other hand, as shown in FIG. 6(b), by pulling out the sub-casing 21, the MPU 1 activiates the sub-display device 3b automatically, and displays the details of the specified received e-mail on the sub-display device 3b. Since in this situation it becomes unnecessary to carry out both the operation in which the user pulls out the sub-casing 21 and the operation of pushing the decision button that displays the details of the received e-mail, an improvement in user-friendliness is obtained. Moreover, where sub-display device 3b is not used, by pushing down the center of the button 8a, the user can choose browser display of the received e-mail, and the MPU1 displays the details of the specified received email on the main display 3a, instead of displaying a received e-mail list.

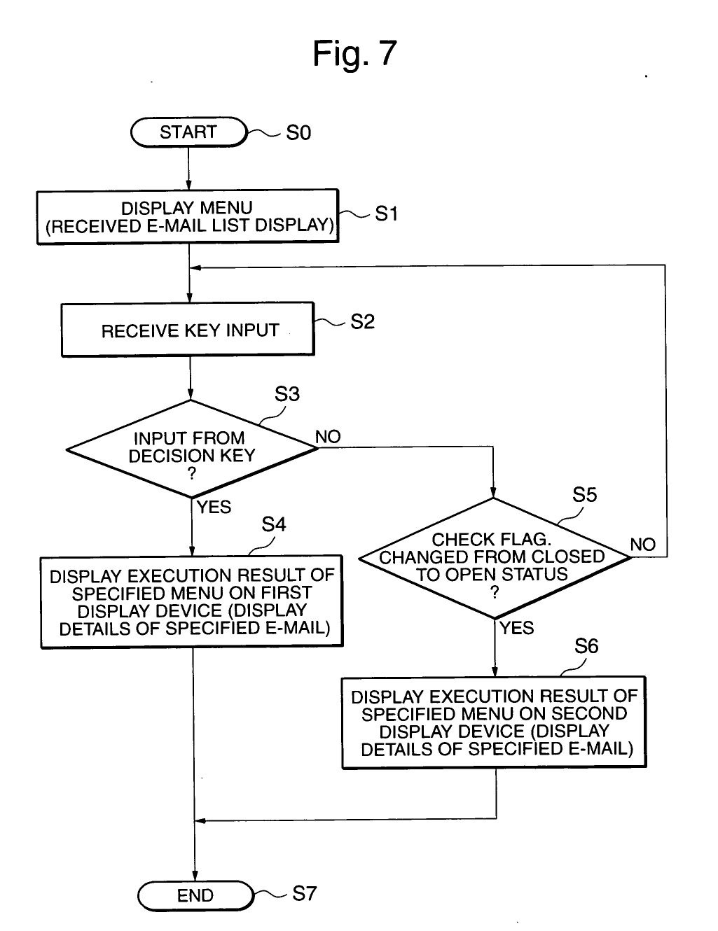

FIG. 7 is a flow chart of the e-mail browsing operations explained using FIG. 6. Here, e-mail browsing is shown as a representative example, but it can be applied to cases where other functions are realized. When the e-mail browsing function is selected by the user, the MPU 1 reads a corresponding program from the memory 9, and starts execution of a browsing program (Step S0). Next, the MPU 1 displays a menu on the main display device 3a (Step S1). In cases of e-mail browsing, the MPU 1 reads from the received email list stored in the memory 9 subject name, sender, and time of data receipt, and describes the subject name, sender, and time of data receipt as images into the video memory of the video circuit 2. In this way, the list of received e-mail is displayed on the main display device 3a.

Next, the MPU 1 performs a key-input receiving process for the operation button 6 (Step S2). Specifically, signals from the operation button 8 are read from I/O controller 6. In addition, by operation of the selector 8a, the MPU 1 performs the process of changing the specified menu option, based on this key input.

Then, the MPU 1 checks whether there is input from a decision key for the selector 8a (Step S3). If “YES”, the MPU 1 executes the process assigned to the menu choice option specified in Step S2, and displays the execution result on the main display device 3a (Step S4). When browsing e-mail, the MPU 1 reads details of specified received e-mail from the memory 9, and displays them on the main display device 3a. Additionally, in this case, in order to secure a displaying area on the main display device 3a, a menu display such as a received e-mail list will be replaced with the execution result (namely, the details of the e-mail).

On the one hand, in cases of “NO” in step S3, a flag stored in the memory 9 is checked and it is determined whether the sub-display device 3b has changed from closed status to open status (Step S5). A configuration for this flag is described later. Here, in cases of “NO”, processing is returned to step S2. On the other hand, in cases of “YES”, the MPU 1 executes the process assigned to the selected option from the specified menu, and displays the execution result on the sub-display device 3b. For example, details of a specified e-mail are displayed on sub-display device 3b. In addition, the menu of the main display device 3a is displayed as it is, without being erased. Therefore, as shown in FIG. 6(b), a menu (list of received e-mails) display is displayed on the main display device 3a, and since the details are displayed on the sub-display device 3b, the user can refer to both displays at once.

After Step S4 or S6 is completed, MPU 1 performs other processing. For example, based on operation of the operation button 6 as in Step S2, edit-processing of reply e-mail or completion-processing of e-mail browsing processes is performed.

In addition, details of a plurality of received e-mails are written in the memory 9. As in the above-stated explanation, when the MPU 1 detects the action of opening the sub-display device 3b, the MPU 1 automatically selects from the plurality of received e-mails and displays on the sub-display device 3b details of one received e-mail.

As mentioned above, according to processing shown in FIGS. 6 and 7, the user can easily switch from using one screen to using two screens. Moreover, since it is possible to execute a selected option after pulling out the sub-casing 21 without having to expressly push the decision button of the selector 8a, the ease of use is greatly improved.

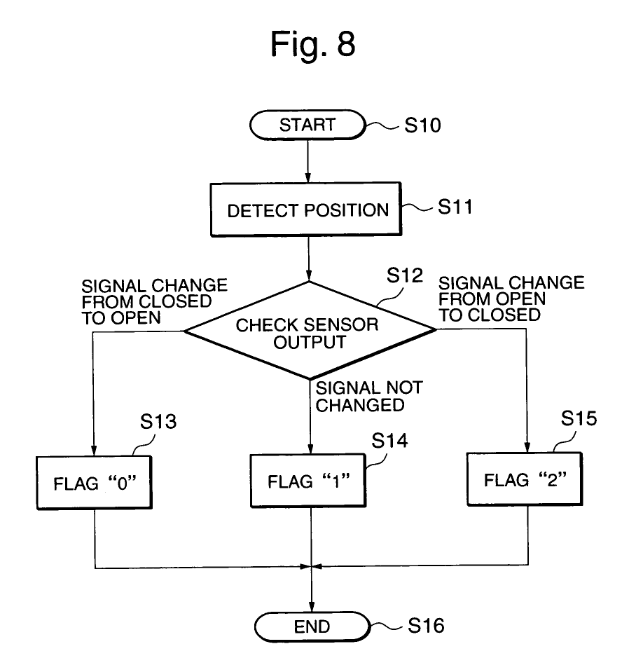

Next, an operation that detects opening-and-closing of the sub-display device 3b is explained, using FIG. 8.

The MPU 1 records changes in the open-closed status of the sub-display device 3b as flags in the memory 9 by performing detection processing through Step S10 at regular intervals.

Firstly, the MPU 1 accesses the I/O controller 6, and detects the position of the sub-display device 3b (Step S11).

For example, as shown in FIG. 2, when the sub-casing 21 is stowed at the back side of the main body casing 20, the switch will output a meaningful signal by the sub-casing 21 depressing the switch that is provided on the main body casing 20.

Next, the MPU 1 judges whether the open/closed status of the sub-display device 3b has changed, based on the signal detected at Step S11 and the signal previously stored in the memory 9. Here, 0 is set as a value of the flag recorded in the memory 9 when the sub-display device 3b has changed from being closed to being open (Step S13). On the other hand, the MPU 1 sets the flag to 1 when the status is not changed (S14).

Furthermore, the MPU 1 sets the flag to 2 when the status is changed from open status to closed status.

By the fact that the MPU 1 operates as mentioned above, various kinds of application programs can refer to the flag and make judgments concerning the open/closed status of the sub-display device 3b.

(2) Help Display

Next, other examples of automatic display of execution results that accompany movement of the sub-display device 3b will be explained.

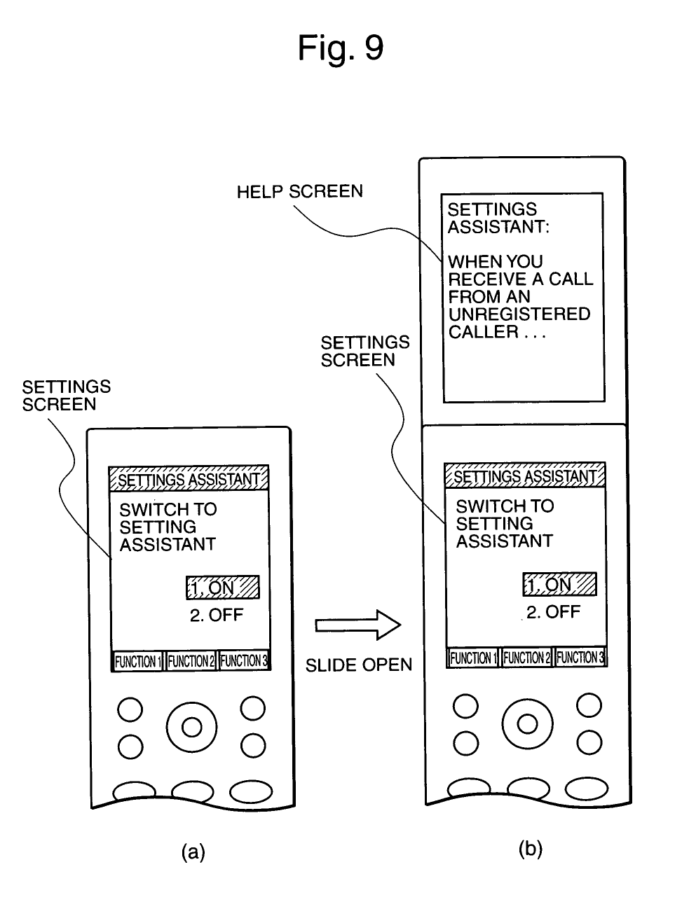

FIG. 9(a) represents a display when the user selects a function-setting option from the main menu. The setting of functions may be realized using publicly-known function-setting technology. Then when a user uses the selector 8a to designate an option that setting a function is desired, and further requires a help explanation concerning the option, the user can refer to the help information by pulling out the sub-casing 21. That is, as shown in FIG. 9(b), when the MPU1 detects that the sub-display device 3b has changed to closed status, it recognizes the option that has been specified on the main display device 3a and displays the help information related to that option on the sub-display device 3b.

By means of the above operations, similarly to the above-mentioned email-browsing function, the user can be provided with an interface that needs few operations and is intuitive and easy to use.

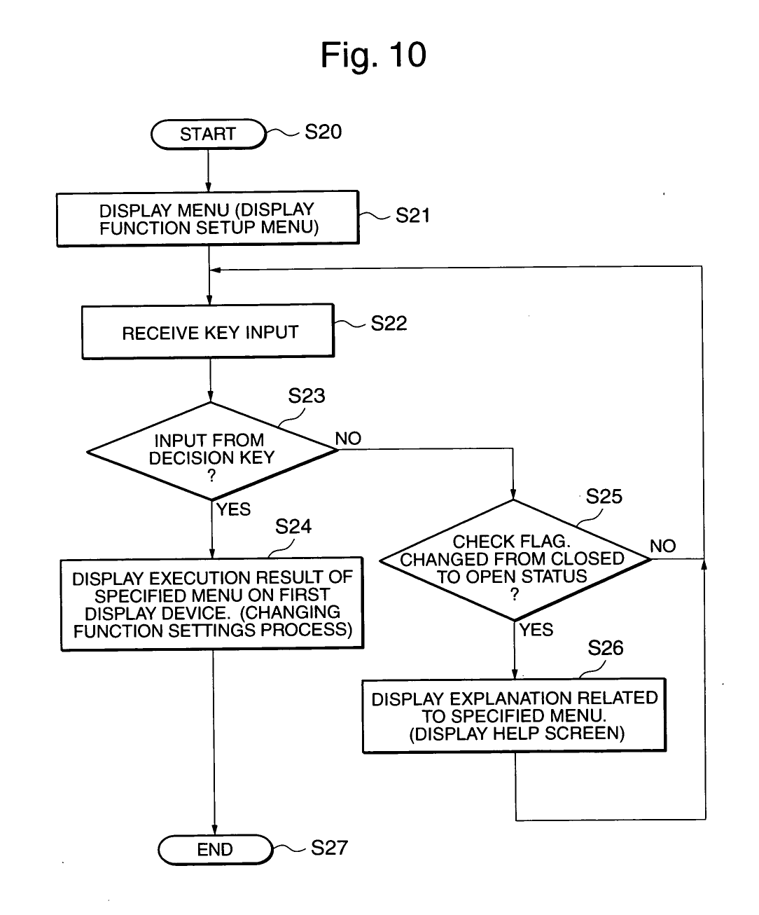

FIG. 10 is a flow chart showing detailed operations concerning the help display. Though the operations in FIG. 10 are different in the received-email browsing and the help-displaying, as compared to those of FIG. 7, the basic operations are the same.

First, the MPU 1 displays a function-setting menu on the main display device 3a (Step S21). Next, the MPU 1 receives key input and performs an option-designating process according to the selector 8a (Step S22). Then, the MPU 1 checks whether there is any input from the selector 8a decision key (Step S23). If “YES”, the MPU 1 performs processing assigned to the option in the menu specified at Step S22, and changes the function setup. An execution result is then displayed on the main display device 3a (Step S24). On the other hand, if “NO”, the flag stored in the memory 9 is checked, and a check is made as to whether the sub-display device 3b has changed from closed status to open status (Step S25). If “NO”, the processing returns to Step S22. On the other hand, if “YES”, the MPU 1 searches for a help explanation related to the option in the specified menu, and reads it from the memory 9. Although a plurality of help explanations is stored in the memory 9, since address information specifying corresponding help explanations is written in the options beforehand, the MPU 1 can select the help easily. Moreover, the MPU 1 displays the help explanations, which have been read, on the sub-display device 3b, and after that, performs processing through Step S22.

Moreover, after Step S24 is completed, the MPU 1 performs other processing—for example, returning to the main menu and carrying out the next processing.

(3) Image Display Switching

Next, an operation, which accompanies an opening or closing operation of the sub-display device 3b, for switching between display of an image display on the user side and of an image received from a communication partner will be explained.

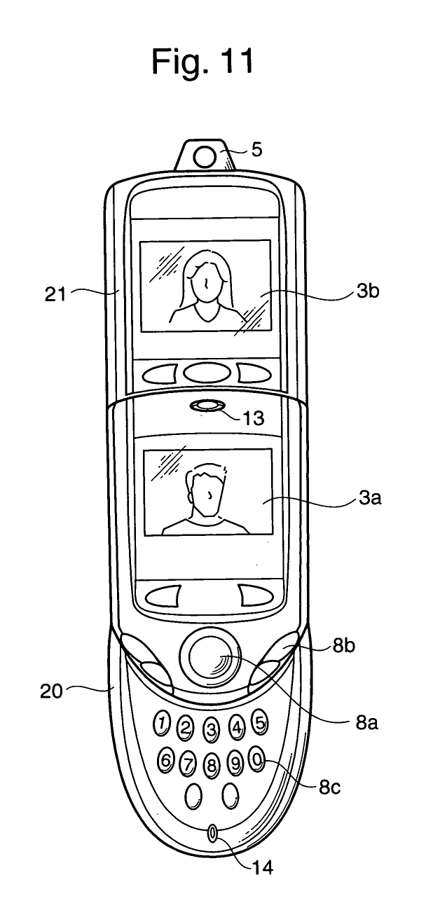

FIG. 11 shows a display during a telephone call using a video telephone call function which sends and receives not only voice but also images.

The sub-display device 3b displays images which are sent from a communication partner and received by the transmitter-receiver circuit 10.

This image is based on data that the video decoder 4 has decoded under MPU 1 control from received data. On the other hand, the main display device 3a displays images taken by the camera 5. The images are encoded by the video encoder 4, and transmitted to the communication partner through the transmitter-receiver circuit 10.

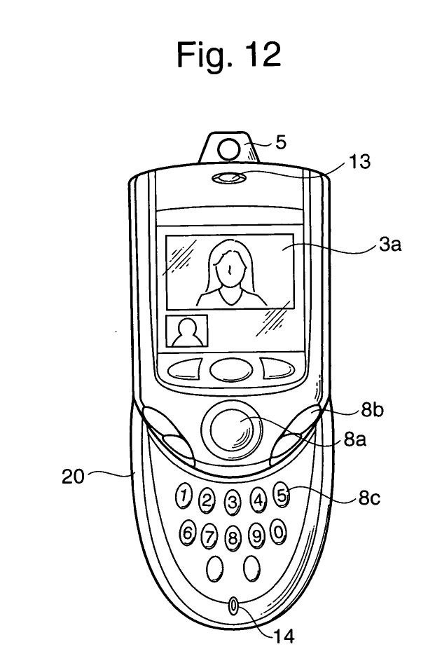

Next, when the user closes the sub-casing 21 and only the main display device 3a is active, as shown in FIG. 12, the MPU 1 detects the change to closed status based on an output signal from the opening-closing sensor 7. Then as shown in FIG. 12, the MPU 1 combines images form a communication partner with images from the camera 5, and displays the combined pictures on the main display device 3a.

Moreover, when the sub-display device 3b changes from closed status to open status, the mobile communications device can also perform double screen display automatically, as shown in FIG. 12 to FIG. 11.

By operating as mentioned above, the user can select the double screen display or single screen display simply by opening and closing the sub-display device 3b. Moreover, the mobile communications device can provide the user with an image display suitable for a telephone call, because the size of the image is changed according to the size of the screen on which the image is displayed, and the two images are combined.

Next, the above-mentioned image display-switching process will be explained in detail.

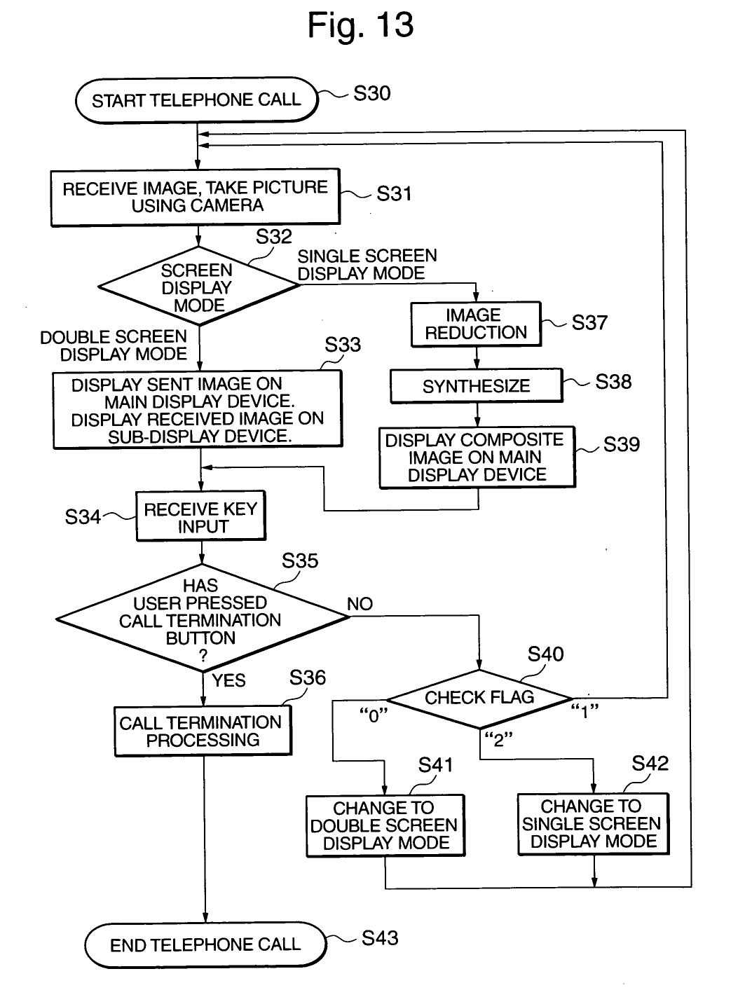

FIG. 13 is a flow chart explaining the image display-switching process. First, when a telephone call process is started under MPU 1 control (Step S30), the transmitter-receiver circuit 10 receives partner image data. At the same time, the camera 5 takes the user's image (Step S31). Next, the MPU 1 checks whether the present display mode is in the single-screen display mode or the double-screen display mode. When in the double screen display mode, the MPU 1 displays the image, taken by the camera 5, on the main display device 3a, and also displays the received image on the sub-display device 3b (Step S33). In addition, at this time, the MPU 1 executes voice telephone call processing using the speaker 13 and the microphone 14, and transmission processing of the image taken, in the same way as for a conventional mobile communications device with a video telephone call function.

Next, owing to detecting operations by the user, the MPU 1 receives key input (Step S34). At this time, the MPU 1, according to input signals from the operation buttons 8, executes telephone call functions prepared beforehand, such as a volume-adjusting process. The MPU 1 then checks whether the user has pushed an operation button 8 assigned to telephone call termination (Step S35). If “YES”, the MPU 1 issues a command to the transmitter-receiver circuit 10 to end the communication, and executes termination of the telephone call (Step S36). If “NO”, the MPU 1 checks the flag for the memory 9, and checks whether the opening-closing status of the sub-display device 3b has changed. When the flag is “0”, since the sub-display device 3b has changed from closed status to open status, the MPU 1 records in the memory 9 that a change to the double-screen display mode has been made (Step S41). When the flag is “2”, since the sub-display device 3b has changed from open status to closed status, the MPU 1 records in the memory 9 that a change to the single screen display mode has been made (Step S42). When Step S41 or S42 is completed, and when the flag is “1”, the MPU 1 reruns the processing from Step S31, and continues processing of the video telephone call.

On the other hand, processing is different for the single-screen display mode. In Step S32, with the single screen mode, the MPU 1 reduces the image taken by the camera 5. This reduction process is easily realizable with publicly known image-processing technology. Next, the MPU 1 combines an image received by the transmitter-receiver circuit 10 with the reduced image, and generates a single composite image (Step S38): Many well-known technologies such as a superimposition functionality, are applicable with respect to the image compositing. The MPU 1 then displays the composite image on the main display device 3a (Step S39). After displaying the composite image, the MPU 1 executes the processing from Step S34 as described above.

The MPU 1 detects opening and closing of the sub-display device 3b as in the foregoing, and can select display mode based on the detection result automatically. Moreover, even when the mobile communications device is being used for a telephone call, switching between the single-screen display mode and the double-screen display mode can be carried out automatically.

(4) Switching Between a Plurality of Applications

As explained in (1) to (3) above, the mobile communications device can execute a plurality of applications (for example, e-mail, function-setting, video replay, Internet browser). When the sub-display device 3b changes from closed status to open status and becomes usable, the execution result of the application currently being executed on the main display device 3a is displayed on the sub-display device 3b. This operation is as explained in (1) to (3) above.

Therefore, when the user pulls out the sub-display device 3b, the MPU1 automatically selects display content in accordance with the present usage situation, and displays the content on the sub-display device 3b. Thus, a user interface which is easy to use can be provided.

(5) Switching of Active Screen

Next, active-screen control that accompanies movement of the sub-display device 3b will be explained.

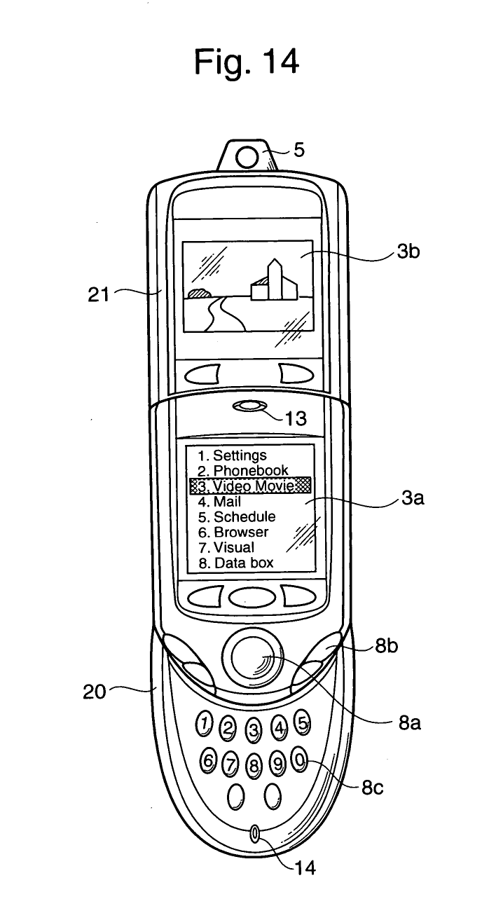

In FIG. 14, the main display device 3a displays a menu, and the sub-display device 3b displays an execution result of a function selected on the menu. The mobile communications device controls a plurality of display devices with the common operation buttons 8. Therefore, for example, it is decided selectively which display devices are concerned with input signals from the selector 8a, and the user can select a display device to operate by pushing a switching key from among the operation buttons 8. Here, the display device that is the object of operation is called the active screen.

FIG. 14 shows a case where the active screen is the main display device 3a, and an oval indicating the selector 8a is displayed in the lower center of the screen. Moreover, in order to highlight-display the active screen, icon displays corresponding to the selector 8a and the software keys 8b are displayed using a highlighting color.

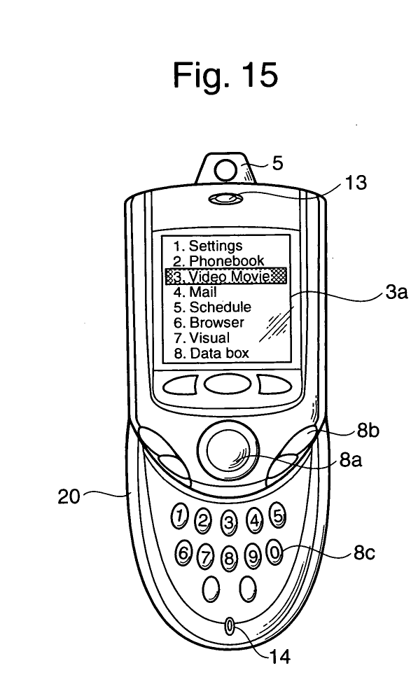

When the sub-display device 3b is changed to closed status from open status, as shown in FIG. 14, the MPU 1 detects the change to closed status, and displays the active screen on the main display device 3a as shown in FIG. 15. In addition, since the menu was originally displayed on the main display device 3a, essential display content do not change here.

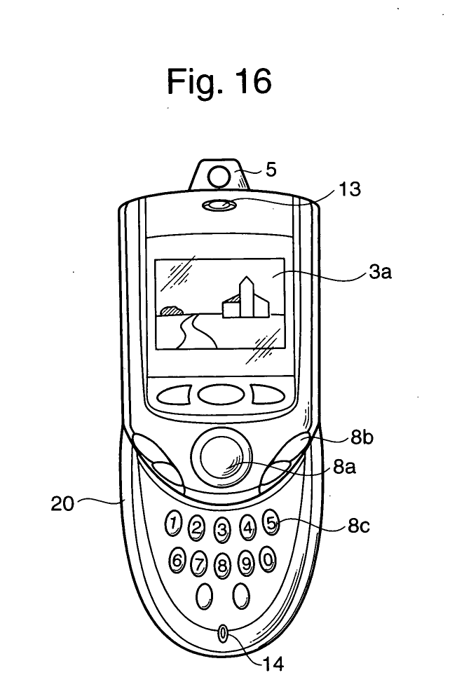

On the other hand, the sub-display device 3b is the active screen in FIG. 14, and the MPU 1 operates as follows, with regard to the situation where an oval icon corresponding to the selector 8a is displayed on the sub-display device 3b. That is, as shown in FIG. 16, a video display that was displayed on the active screen when in open status is displayed instead of the menu that was displayed on the main display device 3a.

As mentioned above, since the mobile communications device updates the main display device 3a from the content of the active screen when the device changes to closed status, even if it has changed to closed status, the user can continue operations dealing with display content of interest.

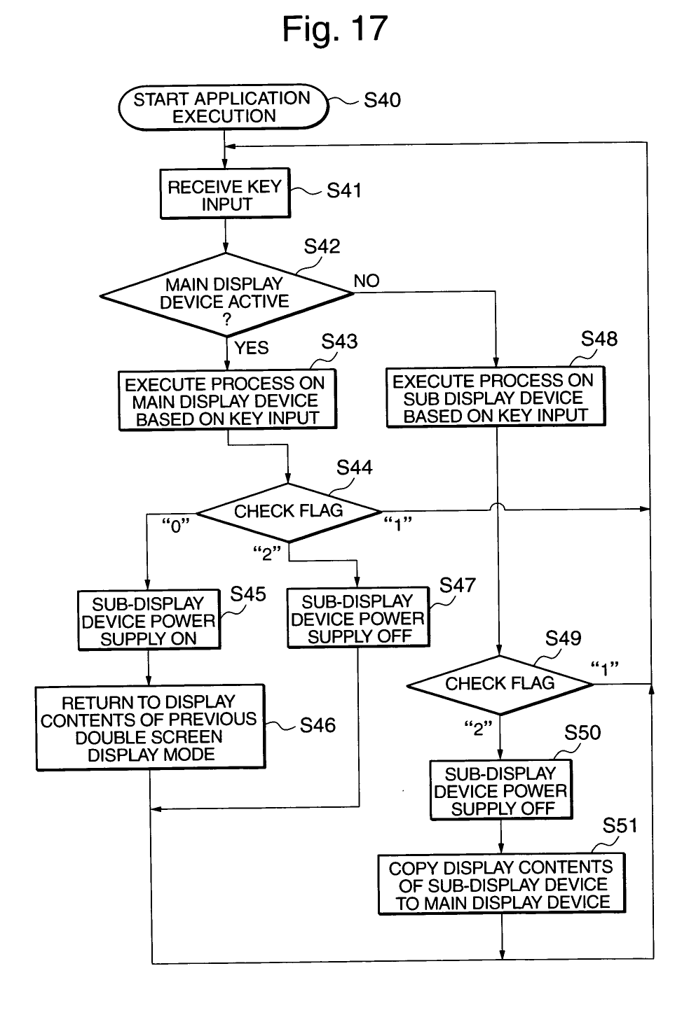

Below, operation details will be explained using FIG. 17.

First, when the MPU 1 starts the execution of an application program (Step S40), it receives key input as described above (Step S41). Next, the MPU 1 checks whether the main display device 3a is the active screen, and if “YES”, executes a process decided by the program beforehand based on the received key input, and displays the result on the main display device 3a (Step S43). Then, the MPU 1 checks the flag (Step S44), and performs Steps S45 and S47 or S41 according to the value of the flag.

When the flag is “2”, since there has been a change to closed status, the MPU 1 sets a back-light power supply for the sub-display device 3b to OFF (Step S47). In addition, at this time the MPU 1 stores in the memory 9 the content displayed by the sub-display device 3b, or the processes being executed in the sub-display device 3b. It then executes the process of Step S41 again.

When the flag is “0”, since there has been a change to open status, the MPU 1 sets the back-light power supply for the sub-display device 3b to ON (Step S45). Next, during the double-display mode it reads the screen composition from the memory 9, and updates the display content of the main display device 3a and the sub-display device 3b based on this result (Step S46).

Next, the situation where the main display device 3a is not the active screen will be explained. The MPU 1 executes a process decided by the program beforehand based on the received key input, and displays the result on the sub-display device 3b (Step S48). Then, the MPU 1 checks the flag (Step S49), and re-performs Step S41 when the value of the flag is “1”.

Moreover, when the value of the flag is “2”, the MPU 1 sets the back-light power supply for the sub-display device 3b to OFF (Step S50), and updates the main display device 3a with display content displayed by the sub-display device 3b (Step S51). At this time, as explained in Step S47, the MPU 1 records in the memory 9 what was being displayed by the main display device 3a and which processing was being performed. Moreover, after processing of Steps S44, S46, S47 or S51 is completed, the MPU 1 executes processing of Step S41 again. In addition, termination of the application is executed when the MPU 1 detects that a termination key has been pushed at Step S43 or Step S48.

By the above processes, it becomes possible to always display the active screen, whether the sub-display device 3b is opened or closed. In addition, although the above explanation outlines a situation where one application is executed, it is also possible to execute a plurality of applications in parallel on respective display devices. When the sub-display device 3b changes to closed status, the handler (resource usage right) of the main display device 3a may be turned over to the application that was being executed on the active screen, and execution of the other applications which were not being executed on the active screen may be continued in the background. In addition, when continuing execution in the background, although the handler for the sub-display device 3b is transferred to other applications, screen updating may or may not be performed.

In addition, when executing a plurality of applications in parallel, the content displayed on the main display device 3a and the content displayed on the sub-display device 3b do not necessarily need to be related.

Moreover, power-supply control for the back light need not be executed in cases where it is not needed.

(6) Other Issues

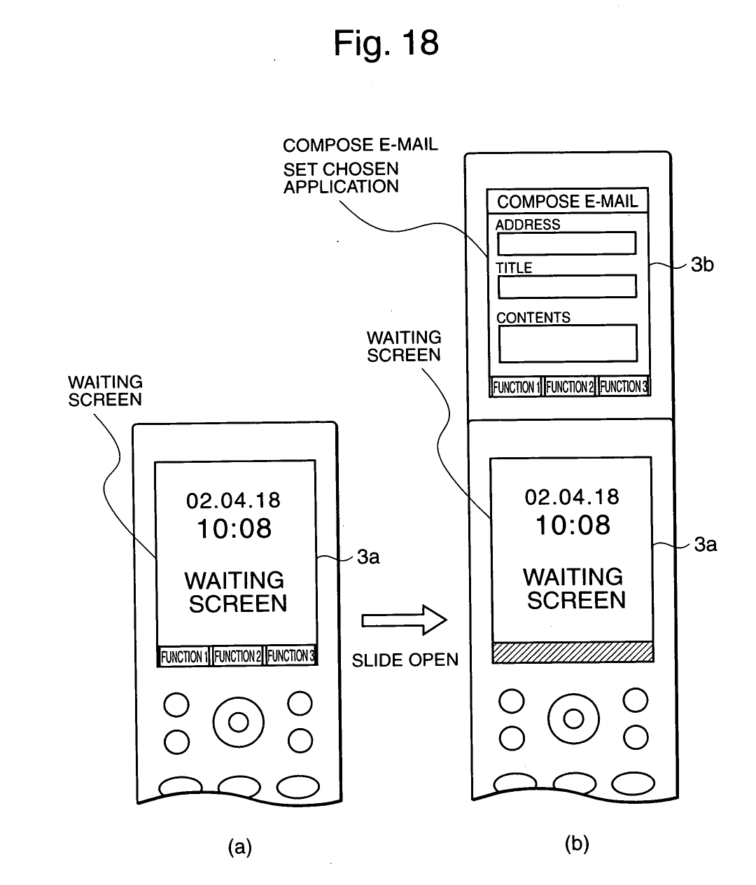

Moreover, the mobile communications device performs operations as shown in FIG. 18-20.

FIG. 18 explains how, when a standby screen is displayed, if the sub-display device 3b is pulled out, the sub-display device 3b operates applications pre-registered by the user. Here, an application for e-mail creation is displayed.

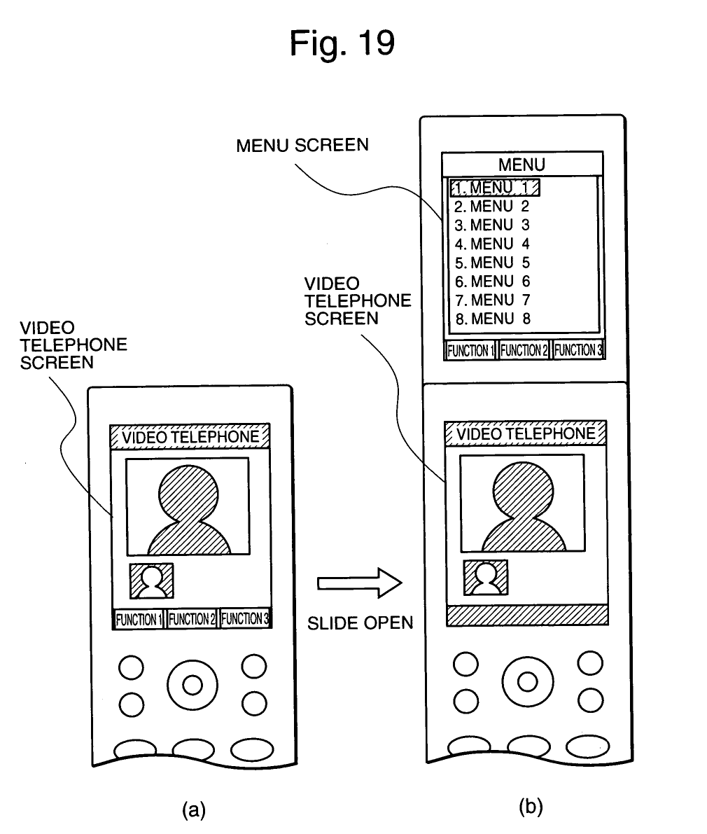

FIG. 19 explains operations when the user pulls out the sub-display device 3b during a telephone call using the video telephone function. The MPU 1 displays a list of option operations, which can be used during a video telephone call, as a menu on the sub-display device 3b.

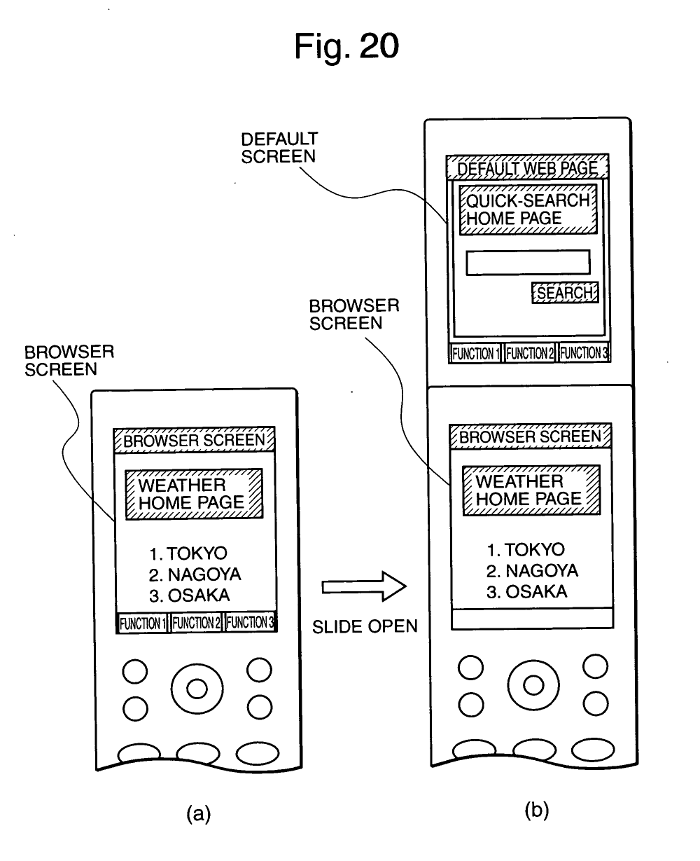

FIG. 20 explains operations when the sub-display device 3b is pulled out while using an Internet browser. The MPU 1 downloads address data initially set by the user and displays the data on the sub-display device 3b.

As mentioned above, although a mobile communications device with an excellent user interface has been explained, the invention is not limited to the above explanation.

For example, although the MPU 1 is exemplified as a control unit, provided that control can be performed as described above, other control means can be used. For example, by integrating the circuits described in FIG. 1, a configuration from one or more ICs (integrated circuits) is also possible. Moreover, use of a specialized circuit, rather than a general-purpose processor, is also feasible.

Moreover, the various decoders also can be realized, not by specialized hardware, but by software.

The opening-closing sensor 7 is not limited to a sensor that essentially outputs a dual-value signal as in a switch, but may use a sensor that outputs multiple values or analog values. It is also possible to obtain an output signal that indicates not only open/closed, but which essentially the distance from the main body casing or the main display device 3a to the sub-display device 3b. A photo-sensor may also be used as the sensor.

Moreover, as long as changes in the position of the sub-display device 3b are detectable, any other means may be used.

Although the operations and configurations, explained in (1) to (5) above, deal with operations on one mobile communications device, all of them are not required, and they can be selected according to required functions.

The transmitter-receiver circuit 10 is not limited to wide area wireless communications as for mobile phones, but may be a circuit for wireless LANs (local area networks), for wireless communications like Bluetooth™ used in comparatively small areas, or for satellite communications in a wider areas. Furthermore, where appropriate, a communications scheme that may be changed, such as software wireless, may also be used.

Although the operation buttons 8 are explained as an example of input devices, input devices are not restricted to button forms, and a device that inputs coordinates by moving a track ball or a stick, or command input device by voice recognition, may also be used. As regards voice recognition, much research is being done and products are being shipped. For example, voice recognition circuits or software installed in car navigation devices may be used. Moreover, an optical device, such as the camera 5, can also be used as the input device. Furthermore, a communications circuit can also be used as an input device. That is, when controlling the mobile communications device by short distance wireless from other devices, the other devices can transmit instructions or menu direction signals, and the MPU 1 can also update a menu according to the direction signals. As other examples, in order to detect movement and inclination of the casing, camera 5 images can be used, or an inclination sensor can also be used.

The display device is not limited to a liquid crystal display device, and other display devices which display character text or images may be used. For example, one display device may be configured by arranging a plurality of LEDs (light emitting diodes), and furthermore, an EL (electroluminescence) display or a PDP (plasma display panel) may also be used.

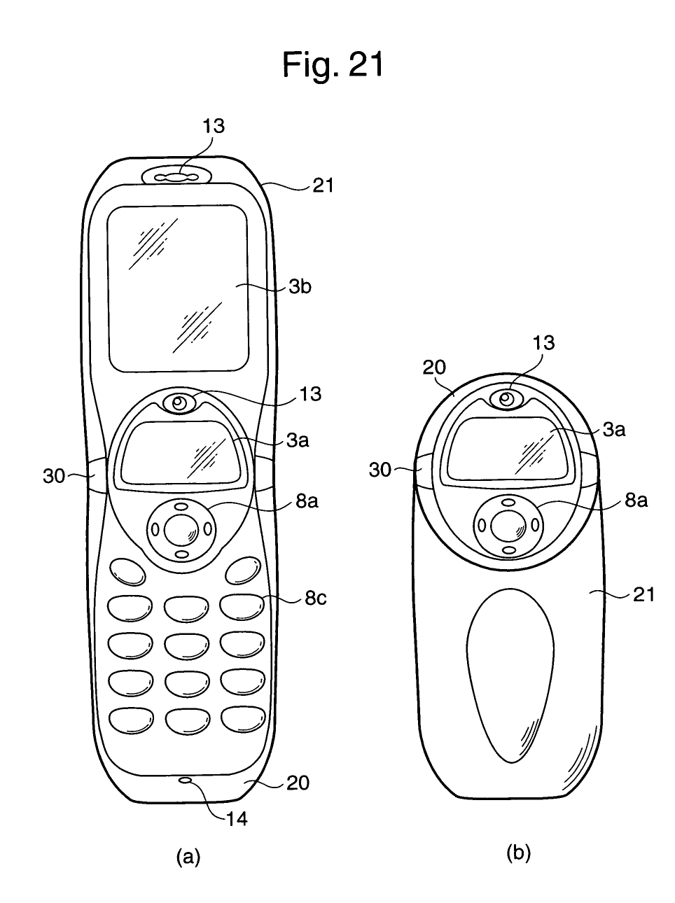

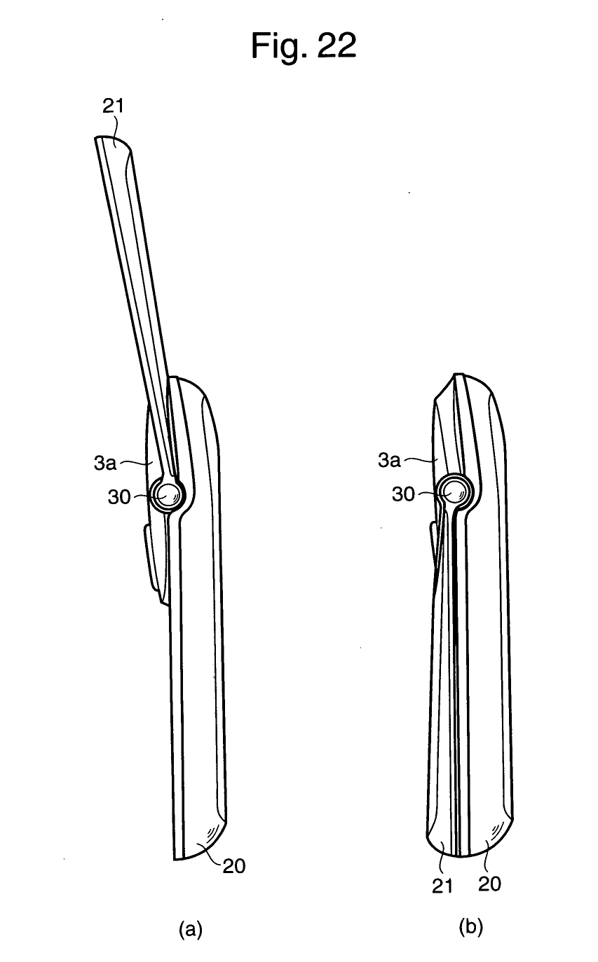

Moreover, the movable display device is not restricted to the sliding member as shown in FIG. 3. For example, a display device set in a casing configured to fold in two and rotate about a hinge is also possible. FIG. 21 and FIG. 22 illustrate this example. FIG. 21 is a front view of the mobile communications device, and FIG. 22 is a side elevational view. In FIG. 21 and FIG. 22, symbols identical with symbols in FIG. 2 refer to the same or equivalent components. The sub-casing 21, which directs the sub-display device 3b, is connected to swivel open and closed in the main body casing 20 by a hinge 30. FIG. 21(a) and FIG. 22(a) show the open status, and FIG. 2(b) and FIG. 22(b) show the closed status. As shown in FIG. 21, the main display device 3a is not hidden by the sub-casing 21 and can be used even where the casing is in closed status. The sub-casing 21 not only rotates in the front direction as shown in FIG. 21, but may rotate in the side directions, and may be configured so as to be hidden at the back side of the main body casing 20 when put away into the sub-casing 21.

Moreover, when combining a plurality of images, reduction processing is not essential. A decision can be made as to whether execution is appropriate or not, according to the screen size and combined image size. In addition, reduction processing of both an image from a communication partner and an image from the camera is also possible.

Each application program is composed of a plurality of routines. Each application program may be integrated in the same computer program, or may be configured in completely separate programs. The application programs do not always need to be stored in the memory 9 and may be downloaded from other devices through a network via a transmitter-receiver circuit. The abovementioned processing is realizable with computer-executable programs. Such a computer program can be recorded on a computer-readable recording medium, or can be downloaded to the mobile communications device by wireless communications.

Moreover, it does not matter which is larger, the size of the main display device 3a or the sub-display device 3b.

### INDUSTRIAL APPLICABLILITY

As mentioned above, a mobile communications device of the invention, and its display-control methods and programs are appropriate, for example, for mobile communications devices such as mobile phones having a plurality of display devices, or mobile information terminals.

1. A mobile communications device comprising:
a casing;
a first display device for displaying text or images;
a second display device arranged on and movable with respect to the casing;
a sensor for outputting an output signal according to position of the second display device;
a control device for executing an application program and controlling the first and second display so as to display a first execution result on the first display device, and to display a second execution result, related to the first execution result, on the second display device based on the output signal from the sensor when the second display device is moved into a predetermined position.

2. The mobile communications device according to claim 1, wherein the control device is configured to enable a plurality of application programs to be executed, and when displaying the second execution result on the second display device, the control device controls the second display device so as to displays the execution result of the application program which is using the first display device.

3. The mobile communications device according to claim 1, wherein the control device executes an email-browsing program as the application program, and the first display device displays a receiving list of e-mails as a first execution result, and the second display device displays content of one e-mail in the receiving list as a second execution result.

4. The mobile communications device according to claim 1, wherein when the second display device is moved into an operable position, the second display device displays a help information for the first execution result currently being displayed.

5. The mobile communications device according to claim 1, wherein the first display device displays a menu having a plurality of displayed options, and when the control device has judged, based on the output signal from the sensor, that the second display device has moved, the control device judges that one option has been selected from the plurality of options.

6. The mobile communications device according to claim 1, wherein, based on the output signal from the sensor, the control device selects on which display device to display a second execution result, and controls the selected display so as to display the second execution result on the first display device or the second display device according to the selection result.

7. The mobile communications device according to claim 1, wherein:
the sensor detects open state and closed state of the second display device; and
when the sensor has detected that the second display device has gone from the open state to the closed state, then the first display device displays a synthesized image generated by synthesizing content displayed on the first display device and content displayed on the second display device in the open state.

8. The mobile communications device according to claim 7, further comprising a camera for taking a first video image; wherein:
each of the first display device and the second display device respectively displays either a second video image sent from a communication partner, or the first video image in the open state; and
when the sensor has detected that the second display device has gone from the open state to the closed state, then the control device reduces the first video image, synthesizes the reduced first video image and the second video image, and controls the first display device so as to displays the synthesized video image on the first display device.

9. The mobile communications device according to claim 1, further comprising an input device for selecting content displayed on the first display device or the second display device; wherein:
based on the output signal from the sensor, the control device determines the second display device will not display,
when what being displayed on the first display device differs from what being displayed on the second display device, the control device selectively determines, as an active screen, the display device, which is to be operated by the input device, from the first and second display devices, that is to be operated as an input display device, and
when the second display device has gone into non-display status the control device updates content on the first display device using content being displayed on the active screen.

10. A display control method for a mobile communications device, the method comprising:
a detection step of detecting whether second display means has changed from being not-in-use to being in-use, wherein first display means and the second display means are provided in the mobile communications device;
a display step of selecting display content related to an option displayed on the first display means from a plurality of display-content items, and displaying the display content on the second display means, when the change into the state of in-use has been detected in the detection step.

11. The mobile-communications-device display control method according to claim 10, wherein in the display step, the second display means displays a next execution result output from an application program that uses the first display means.

12. The mobile-communications-device display control method according to claim 11, wherein in the display step, the first display means displays the next execution result when the second display device means is not being used and a decision button on the mobile communications device has been pressed.

13. The mobile-communications-device display control method according to claim 10, wherein in the detection step, an output signal is detected, the output signal being output from a sensor for detecting that the second display means has moved with respect to the first display means.

14. The mobile-communications-device display control method according to claim 10, further comprising:
a list-display step of displaying on the first display means a receiving list of emails having a plurality of subject headings; and
a designation step of designating one of the e-mails from the receiving list; wherein
in the display step, the second display means displays detailed content of the e-mail designated in the designation step as content for display on the second display means.

15. The mobile-communications-device display control method according to claim 10, further comprising:
a step of receiving a first video image sent from a communication partner;
a step of taking a second video image using a camera provided in the mobile communications device;
a dual-screen display step of displaying the first and the second video images at the same time by the first and the second display means; and
a single-screen display step of synthesizing and displaying on the first display means the first and the second video images when the second display means has gone from being in-use to being not-in-use.

16. The mobile-communications-device display control method according to claim 15, wherein in the single-screen display step, the second video image is reduced and the first and the second video image are synthesized.

17. The mobile-communications-device display control method according to claim 10, wherein when the second display means has gone to being in-use, the second display means displays a help information related to the content displayed on the first display means in the display step.

18. A display control method for a mobile communications device according to claim 10, the method further comprising:
a step of selecting, based on a signal from a first input device provided in the mobile communications device, either the first display means or the second display means as an active screen to be controlled based on a signal from a second input device; and
an update step of updating the content displayed on the first display means using the content displayed on the active screen, when the second display means has gone to being not-in-use.

19. A computer program product for executing on a computer a display-control method comprising:
detecting whether a second display means has changed from being not-in-use to being in-use wherein a first display means and the second display means are provided in a mobile communication device;
selecting display content related to an option displayed on the first display means from a plurality of display-content items, and displaying the display content on the second display means when the change into the state of in-use has been judged in the step of detecting.
